(19) United States
(12) Patent Application Publication
(10) Pub. No.: US 2026/0213076 A1
(43) Pub. Date: Jul. 23, 2026

(54) MULTILAYER ELECTRONIC COMPONENT

(71) Applicant: SAMSUNG ELECTRO-MECHANICS CO., LTD., Suwon-si (KR)

(72) Inventor: Chung Hyeon RYU, Suwon-si (KR)

(73) Assignee: SAMSUNG ELECTRO-MECHANICS CO., LTD., Suwon-si (KR)

(21) Appl. No.: 19/394,023

(22) Filed: Nov. 19, 2025

(30) Foreign Application Priority Data
Jan. 17, 2025 (KR) 10-2025-0007306

(51) Int. Cl. H01G 4/30; H01G 4/012; H01G 4/12

(52) U.S. Cl. CPC H01G 4/30; H01G 4/012; H01G 4/1227; H01G 4/1245

(57) ABSTRACT

A multilayer electronic component includes a body including a dielectric layer and internal electrodes arranged alternately with the dielectric layer and an external electrode disposed on the body, wherein the dielectric layer includes a central portion spaced apart from the internal electrode and including first dielectric grains and an interface portion disposed between the internal electrode and the central portion and including second dielectric grains, wherein Gs2/Gs1<1, Mdy1≤0.1, and 0.1<Mdy2<0.7, in which Gs1 is an average size of the first dielectric grains, Gs2 is an average size of the second dielectric grains, Mdy1 is a number of moles of dysprosium (Dy) relative to 100 moles of Ti in the central portion, and Mdy2 is a number of moles of Dy relative to 100 moles of Ti in the interface portion.

### CROSS-REFERENCE TO RELATED APPLICATION(S)

This application claims benefit of priority to Korean Patent Application No. 10-2025-0007306 filed on Jan. 17, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products, such as image display devices, including liquid crystal displays (LCDs) and plasma display panels (PDPs), computers, smartphones, cell phones, and the like, to allow electricity to be charged therein and discharged therefrom.

Such an MLCC may be used as a component of various electronic devices due to advantages thereof, such as compactness, guaranteed high capacitance, and ease of mounting. As various electronic devices, such as computers and mobile devices, have been reduced in size and increased in power, demand for miniaturization and high capacitance of multilayer ceramic capacitors have been increased.

Furthermore, as the usage environments of multilayer ceramic capacitors diversify, reliability at high temperatures is also required.

The addition of dysprosium (Dy) to dielectric layers may facilitate ensuring reliability in high-temperature environments but there is concern that the capacitance of multilayer ceramic capacitors may decrease.

Therefore, there is a need to develop a multilayer ceramic capacitor having a new structure offering excellent high-temperature reliability and high capacitance.

### SUMMARY

An aspect of the present disclosure is to provide a multilayer electronic component with excellent reliability.

Another aspect of the present disclosure is to provide a multilayer electronic component with excellent high-temperature reliability.

Another aspect of the present disclosure is to provide a multilayer electronic component capable of securing high capacitance.

However, the objects of the present disclosure are not limited to the above-described contents and will be more readily understood when specific embodiments of the present disclosure are described.

According to an aspect of the present disclosure, a multilayer electronic component includes: a body including a dielectric layer and internal electrodes arranged alternately with the dielectric layer; and an external electrode disposed on the body, wherein the dielectric layer includes: a central portion spaced apart from an internal electrode among the internal electrodes, the central portion including first dielectric grains, and an interface portion disposed between the internal electrode and the central portion, the interface portion including second dielectric grains, wherein Gs2/Gs1<1, Mdy1≤0.1, and 0.1<Mdy2<0.7, in which Gs1 is an average size of the first dielectric grains, Gs2 is an average size of the second dielectric grains, Mdy1 is a number of moles of dysprosium (Dy) in the central portion relative to 100 moles of Ti in the central portion, and Mdy2 is a number of moles of Dy in the interface portion relative to 100 moles of Ti in the interface portion.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an exploded view of a body of the embodiment illustrated in FIG. 1; and

FIG. 5 is an enlarged view of region K1 of FIG. 2.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X direction may be defined as a first direction, stacking direction, thickness (T) direction, the Y direction may be defined as a second direction or length (L) direction, and the Z direction may be defined as a third direction or width (W) direction.

### Multilayer Electronic Component

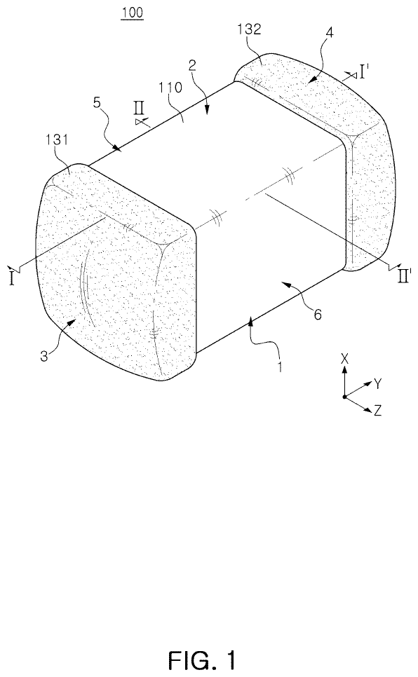

FIG. 1 is a perspective view schematically illustrating a multilayer electronic component according to an embodiment of the present disclosure.

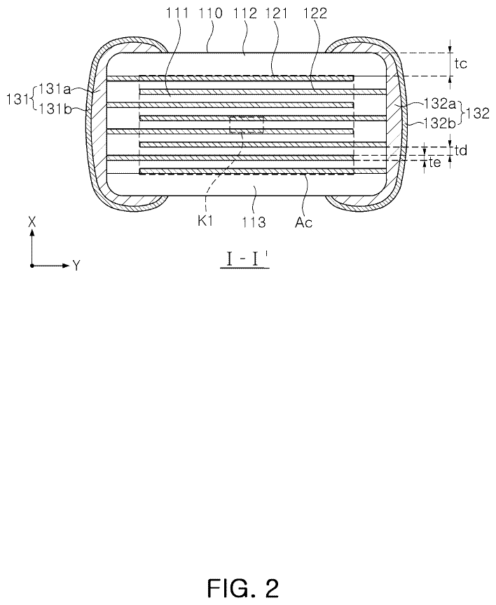

FIG. 2 is a cross-sectional view taken along line I-I′ of FIG. 1.

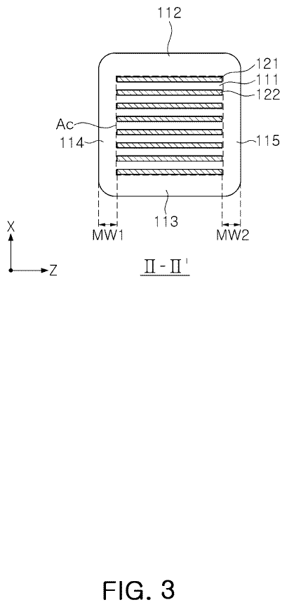

FIG. 3 is a cross-sectional view taken along line II-II′ of FIG. 1.

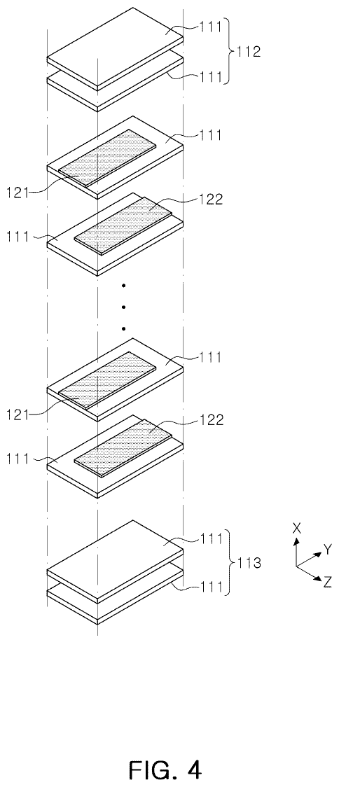

FIG. 4 is an exploded view of a body of the embodiment illustrated in FIG. 1.

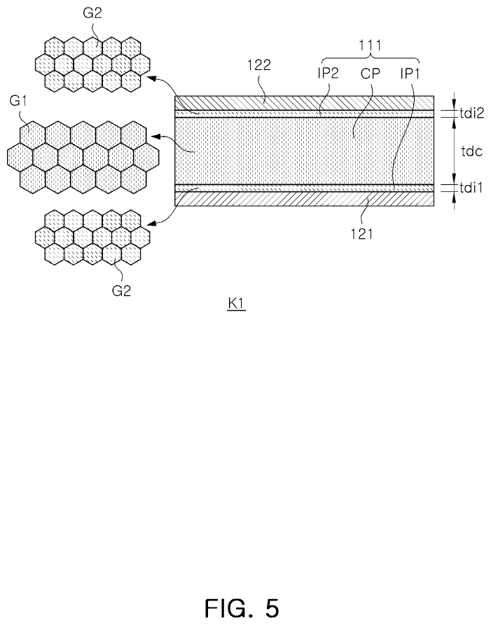

FIG. 5 is an enlarged view of region K1 of FIG. 2.

Hereinafter, a multilayer electronic component 100 according to an embodiment of the present disclosure will be described in detail with reference to FIGS. 1 to 5. Furthermore, while a multilayer ceramic capacitor (MLCC) is described as an example of a multilayer electronic component, the present disclosure is not limited thereto and may be applied to various multilayer electronic components using ceramic materials, such as inductors, piezoelectric devices, varistors, or thermistors.

The multilayer electronic component 100 according to an embodiment of the present disclosure may include a body 110 including a dielectric layer 111 and internal electrodes 121 and 122 alternately arranged with the dielectric layer and external electrodes 131 and 132 arranged on the body, in which the dielectric layer 111 includes a central portion CP spaced apart from the internal electrode and including first dielectric grains G1 and interface portions IP1 and IP2 disposed between the internal electrode and the central portion and including second dielectric grains G2, and Gs2/Gs1<1, Mdy1≤0.1, and 0.1<Mdy2<0.7, in which Gs1 is an average size of the first dielectric grains, Gs2 is an average size of the second dielectric grains, Mdy1 is the number of moles of dysprosium (Dy) relative to 100 moles of Ti in the central portion, and Mdy2 is the number of moles of dysprosium (Dy) relative to 100 moles of Ti in the interface portions.

The addition of Dy to the dielectric layer may facilitate ensuring reliability in high-temperature environments, but there is a concern that the capacitance of the multilayer ceramic capacitor may be reduced.

According to an embodiment of the present disclosure, by increasing the Dy content in the interface portions IP1 and IP2 compared to the central portion CP and reducing the average dielectric grain size, the high-temperature reliability of the multilayer electronic component 100 may be improved while suppressing a capacitance degradation due to the addition of Dy.

Hereinafter, each component included in the multilayer electronic component 100 according to an embodiment of the present disclosure will be described.

The body 110 may include dielectric layers 111 and internal electrodes 121 and 122 that are alternately stacked.

While there are no specific limitations on the specific shape of the body 110, as illustrated, the body 110 may be formed to have a hexahedral shape or a similar shape. Due to shrinkage of ceramic powder particles included in the body 110 during a sintering process, the body 110 may not be a perfectly straight hexahedral shape, but may have a substantially hexahedral shape.

The body 110 may have first and second surfaces 1 and 2: facing in the first direction, third and fourth surfaces 3 and 4 connected to the first and second surfaces 1 and 2 and facing in the second direction, and fifth and sixth surfaces 5 and 6 connected to the first and second surfaces 1 and 2 and the third and fourth surfaces 3 and 4 and facing in the third direction.

As margin regions in which the internal electrodes 121 and 122 are not arranged overlap on the dielectric layer 111, a step difference may be created due to the thickness of the internal electrodes 121 and 122, and thus, the corners connecting the first surface and the third to fifth surfaces and/or the corners connecting the second surface and the third to fifth surfaces may have a shape contracted toward the center of the body 110 in the first direction when viewed based on the first or second surface. Alternatively, due to shrinkage behavior during the sintering process of the body, the corners connecting the first surface 1 to the third to sixth surfaces 3, 4, 5, and 6 and/or the corners connecting the second surface 2 to the third to sixth surfaces 3, 4, 5, and 6 may have a shape contracted toward the center of the body 110 in the first direction when viewed based on the first surface or the second surface. Alternatively, in order to prevent chipping defects, etc., a separate process may be performed to round the corners connecting each surface of the body 110, so that the corners connecting the first surface to the third to sixth surfaces and/or the corners connecting the second surface to the third to sixth surfaces may have a round shape.

Meanwhile, to suppress a step difference caused by the internal electrodes 121 and 122, after stacking, cutting may be performed such that the internal electrodes are exposed to the fifth and sixth surfaces 5 and 6 of the body and a single dielectric layer or two or more dielectric layers may then be stacked on both sides of a capacitance forming portion Ac in the third direction (the width direction) to form the side margin portions 114 and 115. In this case, the portions connecting the first surface to the fifth and sixth surfaces and the portions connecting the second surface to the fifth and sixth surfaces may not have a contracted shape.

The plurality of dielectric layers 111 constituting the body 110 are in a sintered state, and adjacent dielectric layers 111 may be integrated such that boundaries therebetween may not be readily apparent without using a scanning electron microscope (SEM). The number of stacked dielectric layers is not particularly limited and may be determined based on the size of the multilayer electronic component. For example, the body may be formed by stacking 400 or more dielectric layers.

Referring to FIG. 5, the dielectric layer 111 may include the central portion CP spaced apart from the internal electrodes 121 and 122 and including the first dielectric grains G1 and the interface portions IP1 and IP2 disposed between the internal electrodes 121 and 122 and the central portion CP and including the second dielectric grains G2.

Furthermore, Gs2/Gs1<1, Mdy1≤0.1, and 0.1<Mdy2<0.7 may be satisfied, in which Gs1 is the average size of the first dielectric grains G1, Gs2 is the average size of the second dielectric grains G2, Mdy1 is the number of moles of Dy relative to 100 moles of Ti in the central portion CP, and Mdy2 is the number of moles of Dy relative to 100 moles of Ti in the interface portions IP1 and IP2. Accordingly, high-temperature reliability may be secured, while capacitance degradation due to the addition of Dy is suppressed.

If the average size Gs1 of the first dielectric grains is smaller than the average size Gs2 of the second dielectric grains, the high-temperature reliability may be difficult to ensure.

If Mdy1 exceeds 0.1, there is a risk of capacitance degradation. Meanwhile, the central portion CP does not necessarily include Dy. The central portion CP may not include Dy, and thus Mdy1 may be 0.

If Mdy2 is 0.1 or less, high-temperature reliability may be difficult to ensure. If Mdy2 is 0.7 or greater, capacitance degradation may occur. Therefore, it is preferable to satisfy 0.1<Mdy2<0.7, and more preferably, 0.2≤Mdy2≤0.6.

In an embodiment, Gs1 and Gs2 may satisfy Gs2/Gs1<0.7. This may further enhance the capacitance degradation suppression and high-temperature reliability enhancement effects of the present disclosure.

Meanwhile, the specific ranges of Gs1 and Gs2 may not be particularly limited.

For example, in an embodiment, Gs2 may be 50 nm to 180 nm, and Gs1 may be 100 nm to 300 nm. Accordingly, the capacitance degradation suppression and high-temperature reliability enhancement effects of the present disclosure may be further enhanced.

In an embodiment, Gs1 and Gs2 may satisfy the condition Gs1−Gs2>70 nm. Accordingly, the capacitance degradation suppression and high-temperature reliability enhancement effects of the present disclosure may be further enhanced.

Meanwhile, the average size Gs1 of the first dielectric grains, the average size Gs2 of the second dielectric grains, the number of moles Mdy1 of Dy per 100 moles of Ti in the central portion, and the number of moles Mdy2 of Dy per 100 moles of Ti in the interface portions may be measured from an image observed using a scanning electron microscope-energy dispersive X-ray spectrometer (SEM-EDS), a transmission electron microscope-energy dispersive X-ray spectrometer (TEM-EDS), a scanning transmission electron microscope-energy dispersive X-ray spectrometer (STEM-EDS), or a field emission-scanning electron microscope-energy dispersive X-ray spectrometer (FE-SEM-EDS) on the cross-sections of the body 110 in the first and second directions. Other methods and/or tools appreciated by one of ordinary skill in the art, even if not described in the present disclosure, may also be used.

More specifically, the multilayer electronic component 100 is polished to a point halfway in the third direction to expose the cross-section of the multilayer electronic component 100 in the first and second directions. Thereafter, using FE-SEM-EDS (acceleration voltage: 2 kV, magnification: 50,000×), the average size of dielectric grains may be measured at each of the interface portion and the central portion of the dielectric layer disposed in the central portion of the capacitance forming portion Ac in the first direction. Since the size of the dielectric grains changes rapidly at the boundary between the interface portion and the central portion, the interface portion and the central portion may be easily distinguished in the SEM scanned image. The size of the dielectric grains may be measured as an equivalent circular diameter using image analysis software (ImageJ). The sizes of 30 or more dielectric grains in each of the interface portion and the central portion may be averaged and used as Gs1 and Gs2.

Furthermore, the contents (mol %) of Dy and Ti in each of the interface portion and the central portion are measured. From this, the number of moles of Dy relative to 100 moles of Ti in the interface portion and central portion may be calculated to obtain Mdy1 and Mdy2, respectively.

Meanwhile, by selecting ten dielectric layers respectively arranged in the upper, central, and lower portions of the capacitance forming portion Ac in the first direction, Gs1, Gs2, Mdy1, and Mdy2 may be calculated from a total of 30 dielectric layers, and then the average value of the values may be calculated to generalize Gs1, Gs2, Mdy1, and Mdy2.

In an embodiment, the internal electrodes 121 and 122 may include a first internal electrode 121 and a second internal electrode 122 alternately arranged with the dielectric layer 111 interposed therebetween, and the interface portions IP1 and IP2 may include a first interface portion IP1 disposed between the central portion CP and the first internal electrode 121 and a second interface portion IP2 disposed between the central portion CP and the second internal electrode 122.

In an embodiment, when an average thickness of the first interface portion IP1 is tdi1, an average thickness of the second interface portion IP2 is tdi2, and the average thickness of the central portion CP is tdc, tdi1/tdc≤0.05 and tdi2/tdc≤0.05 may be satisfied. If tdi1/tdc exceeds 0.05 or tdi2/tdc exceeds 0.05, the capacitance degradation suppression effect according to the present disclosure may be insufficient.

Meanwhile, the specific ranges of tdi1, tdi2, and tdc may not be particularly limited.

For example, in an embodiment, tdi1 and tdi2 may each be 50 nm or greater and 500 nm or less.

In an embodiment, tdc may be 1,000 nm or greater.

In an embodiment, the sum of tdi1, tdi2, and tdc is 1.05 μm or greater and 10 μm or less. Here, the sum of tdi1, tdi2, and tdc may refer to the average thickness td of the dielectric layer.

Here, tdi1, tdi2, and tdc may represent the thicknesses in the first direction. tdi1, tdi2, and tdc may be measured by scanning cross-sections of the body 110 in the first and second directions using a scanning electron microscope (SEM) at 10,000× magnification. The thicknesses of the first interface portion IP1, the second interface portion IP2, and the central portion CP may be measured at 30 equally spaced points in the second direction, and respective average values thereof may be determined. These 30 equally spaced points may be designated in the capacitance forming portion Ac to be described below. Furthermore, by extending this average value measurement to ten dielectric layers 111 and measuring the average values, tdi1, tdi2, and tdc may be further generalized. Other methods and/or tools appreciated by one of ordinary skill in the art, even if not described in the present disclosure, may also be used.

The method of forming the dielectric layer 111 is not particularly limited.

For example, a ceramic green sheet is prepared by applying a ceramic slurry including ceramic powder particles for central portions, ceramic powder particles for interface portions with a smaller average particle size than that of the ceramic powder particles for central portions, an organic solvent, and a binder onto a carrier film. Here, the ceramic green sheet may be manufactured so that the ceramic powder particles for interface portions, the ceramic powder particles for central portions, and the ceramic powder particles for interface portions are sequentially arranged. Here, the ceramic green sheet may be manufactured such that the ceramic powder particles for interface portions, the ceramic powder particles for central portions, and the ceramic powder particles for interface portions are sequentially stacked. Furthermore, the ceramic green sheet may be manufactured so that the Dy content in the region in which the ceramic powder particles for interface portions are located is higher than that in the region in which the ceramic powder particles for central portions are located. Thereafter, the ceramic green sheet may be sintered to form a dielectric layer.

For example, the ceramic powder particles for central portions may have a particle size of 100 nm to 250 nm, and the ceramic powder particles for interface portions may have a particle size of 70% or less than that of the ceramic powder particles for central portions.

The ceramic powder particles for central portions and the ceramic powder particles for interface portions are not particularly limited as long as they may achieve sufficient electrostatic capacitance. For example, barium titanate (BaTiO₃)-based powder particles may be used as the ceramic powder particles for central portions and the ceramic powder particles for interface portions. More specifically, the ceramic powder particles for central portions and the ceramic powder particles for interface portions may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

Therefore, in an embodiment, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1) as a main component. Here, the main component may mean that the number of moles of the other components than the main component is 30 moles or less, as compared to 100 moles of the main component.

The body 110 may include the capacitance forming portion Ac formed within the body 110 and including the first internal electrode 121 and the second internal electrode 122 disposed to face each other with the dielectric layer 111 interposed therebetween to form capacitance and cover portions 112 and 113 formed on upper and lower surfaces of the capacitance forming portion Ac in the first direction.

Furthermore, the capacitance forming portion Ac contributes to the capacitance formation of the capacitor and may be formed by repeatedly stacking a plurality of first and second internal electrodes 121 and 122 with the dielectric layer 111 interposed therebetween.

The cover portions 112 and 113 may include an upper cover portion 112 disposed on the upper surface of the capacitance forming portion Ac in the first direction and the lower cover portion 113 disposed on the lower surface of the capacitance forming portion Ac in the first direction.

The upper cover portion 112 and the lower cover portion 113 may be formed by stacking a single dielectric layer or two or more dielectric layers on the upper and lower surfaces of the capacitance forming portion Ac, respectively, in the thickness direction and may fundamentally prevent damage to the internal electrodes due to physical or chemical stress.

The upper cover portion 112 and lower cover portion 113 do not include internal electrodes and may include the same material as that of the dielectric layer 111.

That is, the upper cover portion 112 and lower cover portion 113 may include a ceramic material, for example, a barium titanate (BaTiO₃)-based ceramic material.

Meanwhile, the thickness of the cover portions 112 and 113 may not be particularly limited. However, to facilitate miniaturization and high-capacitance multilayer electronic components, the thickness tc of the cover portions 112 and 113 may be 15 μm or less.

The average thickness tc of the cover portions 112 and 113 may refer to a value obtained by averaging the sizes of the cover portions 112 and 113 measured at five equally spaced points above or below the capacitance forming portion Ac in the first direction.

Furthermore, margin portions 114 and 115 may be disposed on the side surfaces of the capacitance forming portion Ac.

The margin portions 114 and 115 may include a first margin portion 114 disposed on the fifth surface 5 of the body 110 and a second margin portion 115 disposed on the sixth surface 6. In other words, the margin portions 114 and 115 may be disposed on both end surfaces of the ceramic body 110 in the width direction.

As illustrated in FIG. 3, the margin portions 114 and 115 may refer to a region between both ends of the first and second internal electrodes 121 and 122 and the boundary of the body 110 in a cross-section of the body 110 taken in the width-thickness (W-T) direction.

The margin portions 114 and 115 may fundamentally serve to prevent damage to the internal electrodes due to physical or chemical stress.

The margin portions 114 and 115 may be formed by applying conductive paste to the ceramic green sheet, excluding the region in which the margins will be formed, to form the internal electrodes.

In addition, to suppress a step difference caused by the internal electrodes 121 and 122, after stacking, cutting may be performed such that the internal electrodes are exposed to the fifth and sixth surfaces 5 and 6 of the body, and then, a single dielectric layer or two or more dielectric layers may be stacked on both sides of the capacitance forming portion Ac in the third direction (width direction) to form the margin portions 114 and 115.

Meanwhile, the width of the margin portions 114 and 115 may not be particularly limited. However, to facilitate miniaturization and high capacitance of multilayer electronic components, the average width of the margin portions 114 and 115 may be 15 μm or less.

The average width of the margin portions 114 and 115 may refer to the average size MW1 of the region in which the internal electrode is spaced apart from the fifth surface in the third direction and the average size MW2 of the region in which the internal electrode is spaced apart from the sixth surface in the third direction and may be the average value of the sizes of the margin portions 114 and 115 measured at five equally spaced points on the side surface of the capacitance forming portion Ac in the third direction.

Therefore, in an embodiment, the average sizes MW1 and MW2 of the regions in which the internal electrodes 121 and 122 are spaced apart from the fifth and sixth surfaces in the third direction may each be 15 μm or less.

The internal electrodes 121 and 122 may include first and second internal electrodes 121 and 122. The first and second internal electrodes 121 and 122 are alternately arranged to face each other with the dielectric layer 111 forming the body 110 interposed therebetween and may be exposed through the third and fourth surfaces 3 and 4 of the body 110, respectively.

The first internal electrode 121 may be spaced apart from the fourth surface 4 and exposed through the third surface 3, while the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may be connected to the first external electrode 131 and not to the second external electrode 132, and the second internal electrode 122 may be connected to the second external electrode 132 and not to the first external electrode 131. Therefore, the first internal electrode 121 may be formed at a predetermined distance from the fourth surface 4, and the second internal electrode 122 may be formed at a predetermined distance from the third surface 3. In addition, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, W, Ti, and alloys thereof, but the present disclosure is not limited thereto.

An average thickness the of the internal electrodes may not be particularly limited. Here, the thickness of the internal electrodes 121 and 122 may refer to the size of the internal electrodes 121 and 122 in the first direction.

However, to facilitate miniaturization and high capacitance of the multilayer electronic component, the average thickness of the internal electrodes 121 and 122 may be 0.4 μm or less.

Here, the average thickness the of the internal electrodes may be measured by scanning the cross-sections of the body 110 in the first and second directions using a scanning electron microscope (SEM) at 10,000× magnification. More specifically, the average value may be obtained by measuring the thicknesses at a plurality of points on one internal electrode 121 or 122, for example, 30 equally spaced points in the second direction. The 30 equally spaced points may be designated in the capacitance forming portion Ac. Furthermore, by extending this average measurement to ten internal electrodes 121 and 122, the average thickness of the internal electrodes 121 and 122 may be further generalized.

The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include first and second external electrodes 131 and 132 connected to the first and second internal electrodes 121 and 122, respectively.

Referring to FIG. 1, the external electrodes 131 and 132 may be arranged to cover both end surfaces of the side margin portions 114 and 115 in the second direction.

In the present embodiment, a structure in which the multilayer electronic component 100 has two external electrodes 131 and 132 is described. However, the number and shape of the external electrodes 131 and 132 may vary depending on the shape of the internal electrodes 121 and 122 or other purposes.

Meanwhile, the external electrodes 131 and 132 may be formed using any material having electrical conductivity, such as metal. A specific material may be determined based on electrical characteristics, structural stability, and other factors. Furthermore, the external electrodes may have a multilayer structure.

For example, the external electrodes 131 and 132 may include electrode layers 131a and 132a disposed on the body 110 and plating layers 131b and 132b formed on the electrode layers 131a and 132a.

More specifically, the electrode layers 131a and 132a may be sintered electrodes including a conductive metal and glass or resin-based electrodes including a conductive metal and resin.

Furthermore, the electrode layers 131a and 132a may be formed by sequentially forming sintered electrodes and resin-based electrodes on the body. Furthermore, the electrode layers 131a and 132a may be formed by transferring a sheet including a conductive metal onto the body or by transferring a sheet including a conductive metal onto a sintered electrode.

The conductive metal included in the electrode layers 131a and 132a may be any material with excellent electrical conductivity and is not particularly limited. For example, the conductive metal may be one or more of nickel (Ni), copper (Cu), and alloys thereof.

The plating layers 131b and 132b serve to improve mounting characteristics. The type of plating layers 131b and 132b is not particularly limited and may include one or more of nickel, tin, palladium, and alloys thereof, and may be formed as a plurality of layers.

More specifically, the plating layers 131b and 132b may be Ni or Sn plating layers. An Ni plating layer and an Sn plating layer may be sequentially formed on the electrode layers 131a and 132a, or an Sn plating layer, an Ni plating layer, and an Sn plating layer may be sequentially formed. In addition, the plating layers 131b and 132b may include a plurality of Ni plating layers and/or a plurality of Sn plating layers.

The size of the multilayer electronic component 100 is not particularly limited. For example, the size of the multilayer electronic component 100 may be 0201 (length×width, 0.2 mm×0.1 mm), 0603 (length×width, 0.6 mm×0.3 mm), 1005 (length×width, 1.0 mm×0.5 mm), etc.

### Method of Manufacturing Multilayer Electronic Component

Hereinafter, an example of a method of manufacturing the multilayer electronic component 100 according to an embodiment of the present disclosure will be described. However, the method of manufacturing the multilayer electronic component 100 of the present disclosure is not limited thereto.

First, a ceramic slurry including ceramic powder particles for central portions, ceramic powder particles for interface portions with a smaller average particle size than that of the ceramic powder particles for central portions, an organic solvent, and a binder is applied onto a carrier film to prepare a ceramic green sheet. The ceramic green sheet may be manufactured such that the ceramic powder particles interface portions, the ceramic powder particles for central portions, and the ceramic powder particles for interface portions are sequentially arranged.

The ceramic green sheet may be manufactured such that the ceramic powder particles for interface portions, the ceramic powder particles for central portions, and the ceramic powder particles for interface portions are sequentially stacked. Furthermore, the ceramic green sheet may be manufactured such that the Dy content in the region in which the ceramic powder particles for interface portions are disposed is higher than that in the region in which the ceramic powder particles for central portions are disposed.

For example, the ceramic powder particles for central portions may have a particle size of 100 nm to 250 nm, and the ceramic powder particles for interface portions may have a particle size that is 70% or less than that of the ceramic powder particles for central portions.

Thereafter, a conductive paste for internal electrodes, including metal powder particles, a binder, and an organic solvent, may be printed onto the ceramic green sheet with a certain thickness using a screen printing or gravure printing method to form an internal electrode pattern, thereby manufacturing a ceramic green sheet for capacitance forming portions.

Ceramic green sheets for capacitance forming portions may be stacked in the X direction to form a stack. Ceramic green sheets without internal electrode patterns may be stacked on the upper and lower portions of the stack to form the cover portions 112 and 113 after sintering.

The stack is then cut to a predetermined chip size. The end portions of the internal electrode patterns are exposed to both sides of the cut chip facing in the third direction.

Thereafter, a sheet for forming margin portions may be attached to both sides of the cut chip facing in the third direction and then sintered to form the body 110 and the side margin portions 114 and 115. A sintering temperature may be, for example, 1000° C. or higher and 1400° C. or lower, but the present disclosure is not limited thereto.

The sheet for forming margin portions is not particularly limited, and the general ceramic green sheet described above may be used.

Thereafter, the external electrodes 131 and 132 are formed. For example, when base electrode layers 131a and 132a include a sintered electrode layer, the body 110 may be dipped in a conductive paste for external electrodes, including metal powder particles, glass frit, a binder, and an organic solvent, and then the conductive paste for external electrodes may be sintered at a temperature of 500° C. to 900° C. to form a sintered electrode layer.

For example, when the base electrode layers 131a and 132a include a resin electrode layer, the body may be dipped in a conductive resin composition including metal powder particles, a resin, a binder, and an organic solvent, followed by curing heat treatment at a temperature of 250° C. to 550° C. to form a resin electrode layer.

In addition, electrolytic plating and/or electroless plating may be additionally performed to form plating layers 131b and 132b on the base electrode layers 131a and 132a.

### Experimental Example

Sample chips having 1005 size (length: approximately 1.0 mm, width: approximately 0.5 mm, thickness: approximately 0.5 mm) were prepared using the manufacturing method described above.

Sample chips were fabricated so that the average size Gs1 of the first dielectric grains, the average size Gs2 of the second dielectric grains Gs2, the number of moles Mdy1 of Dy per 100 moles of Ti in the central portion, and the number of moles Mdy2 of Dy per 100 moles of Ti in the interface portion satisfied the values listed in Table 1.

The average size Gs1 of the first dielectric grains, the average size Gs2 of the second dielectric grains Gs2, the number of moles Mdy1 of Dy per 100 moles of Ti in the central portion, and the number of moles Mdy2 of Dy per 100 moles of Ti in the interface portion were measured by analyzing the cross-sections of the sample chips in the first and second directions, polished to the half point of the sample chips in the third direction, using FE-SEM-EDS (acceleration voltage: 2 kV, magnification: 50,000×).

The capacitances of the sample chips were measured at 1 kHz using an LCR meter, and the relative values thereof are listed in Table 1.

In addition, a high-temperature load test was conducted on the sample chips for each test number at 150° C. and 100 V. The time until the insulation resistance fell below 10 KΩ was measured as the mean time to failure (MTTF) and is listed in Table 1 below.

TABLE 1

| | Test No. | | | | | | |
|---|---|---|---|---|---|---|---|
| | 1 | 2 | 3 | 4 | 5 | 6 | 7 |
| Gs1 | 250 | 250 | 250 | 250 | 250 | 250 | 250 |
| Gs2 | 170 | 170 | 170 | 170 | 170 | 170 | 170 |
| Mdy1 | 0 | 0 | 0.1 | 0.1 | 0.1 | 0.4 | 0.4 |
| Mdy2 | 0 | 0.1 | 0.1 | 0.4 | 0.7 | 0.4 | 0.7 |
| Capacitance (%) | 103.34 | 102.08 | 101.02 | 100.58 | 95.05 | 88.05 | 86.25 |
| MTTF (hr) | 15 | 48 | 53 | 116 | 122 | 122 | 151 |

Referring to Table 1, Test No. 1, in which Mdy1 and Mdy2 are 0, exhibits the best capacitance but poor high-temperature reliability. Test Nos. 2 and 3, which included small amounts of Dy, also exhibit poor high-temperature reliability. Test Nos. 5 to 7 exhibited reduced capacitance due to the high addition amount of Dy.

In contrast, Test No. 4, which satisfies the conditions Gs2/Gs1<1, Mdy1≤0.1, and 0.1<Mdy2<0.7, exhibited excellent high-temperature reliability, while suppressing capacitance degradation.

One of the various effects of the present disclosure is that the reliability of the multilayer electronic component may be improved by controlling the average dielectric grain size and Dy content at the interface portion and central portion of the dielectric layer.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and internal electrodes arranged alternately with the dielectric layer; and
an external electrode disposed on the body,
wherein the dielectric layer includes:
a central portion spaced apart from an internal electrode among the internal electrodes, the central portion including first dielectric grains, and
an interface portion disposed between the internal electrode and the central portion, the interface portion including second dielectric grains,
wherein Gs2/Gs1<1, Mdy1≤0.1, and 0.1<Mdy2<0.7, in which Gs1 is an average size of the first dielectric grains, Gs2 is an average size of the second dielectric grains, Mdy1 is a number of moles of dysprosium (Dy) in the central portion relative to 100 moles of Ti in the central portion, and Mdy2 is a number of moles of Dy in the interface portion relative to 100 moles of Ti in the interface portion.

2. The multilayer electronic component of claim 1, wherein Gs1 and Gs2 satisfy Gs2/Gs1<0.7.

3. The multilayer electronic component of claim 1, wherein Gs2 is 50 nm or more and 180 nm or less, and Gs1 is 100 nm or more and 300 nm or less.

4. The multilayer electronic component of claim 1, wherein Gs1 and Gs2 satisfy Gs1−Gs2>70 nm.

5. The multilayer electronic component of claim 1, wherein Mdy2 is 0.2 or more and 0.6 or less.

6. The multilayer electronic component of claim 1, wherein Mdy1 is 0.

7. The multilayer electronic component of claim 1, wherein
the internal electrodes include a first internal electrode, and a second internal electrode, the first internal electrode and the second internal electrode alternately arranged with the dielectric layer in between, and
the interface portion includes:
a first interface portion disposed between the central portion and the first internal electrode, and
a second interface portion disposed between the central portion and the second internal electrode.

8. The multilayer electronic component of claim 7, wherein tdi1/tdc≤0.05 and tdi2/tdc≤0.05, in which tdi1 is an average thickness of the first interface portion, tdi2 is an average thickness of the second interface portion, and tdc is an average thickness of the central portion.

9. The multilayer electronic component of claim 8, wherein tdi1 and tdi2 are each 50 nm or more and 500 nm or less.

10. The multilayer electronic component of claim 8, wherein tdc is 1000 nm or more.

11. The multilayer electronic component of claim 8, wherein a sum of tdi1, tdi2, and tdc is 1.05 μm or more and 10 μm or less.

12. The multilayer electronic component of claim 1, wherein the dielectric layer includes a main component that includes at least one selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).
